(19) United States
(12) Patent Application Publication
(10) Pub. No.: US 2014/0201205 A1
(43) Pub. Date: Jul. 17, 2014

(54) Customized Content from User Data

(71) Applicant: DISNEY ENTERPRISES, INC., Burbank, CA (US)

(72) Inventors: Steven Makofsky, Sammamish, WA (US); Paul Cutsinger, Redmond, WA (US)

(73) Assignee: Disney Enterprises, Inc., Burbank, CA (US)

(21) Appl. No.: 13/741,282

(22) Filed: Jan. 14, 2013

(51) Int. Cl. G06F 17/30

(52) U.S. Cl. CPC G06F 17/30386
USPC 707/736

(57) ABSTRACT

There is provided a system and a method for customized content from user data. The method comprising receiving data corresponding to a user of a device, processing a content with the data to create a customized content, and outputting the customized content for display to the user. The data may be received from a device sensor, such as a GPS, camera, accelerometer, or receiver. The data may correspond to location data at a location of a user, and the content may be customized to mimic or contrast the location data. Additionally, the data may correspond to user information saved in a user database, such as a music library or personal profile. In certain implementations, the content may correspond to a virtual environment and the customized content may correspond to a customized virtual environment.

### BACKGROUND

Users often utilize devices to view, interact, or otherwise consume broad range of content throughout their daily lives. For example, users may form music playlists, browse photographs, engage in conversations and content sharing on social media platforms, play video games, and participate in virtual worlds. When users interact with content through user devices, they are given a few selectable options to feel more immersed with the content. For example, a user in an online music application may make a music playlist from a genre or artist they enjoy. Additionally, a user of a video game may choose graphic settings or design an avatar for use in the video game. User devices with a broad range of features and sensors have made accessing and uploading content easier for users. However, these options require active input from users to determine and/or update the appropriate content.

Currently, content, for example virtual experiences, receive a substantial amount of general settings that are universal throughout the platform. Thus, users in different locations experience the same virtual environment regardless of the user's surrounding real-world environment. A common virtual world is a massive multiplayer online (MMO) video game. MMO video games have substantial and detailed worlds that often span massive virtual areas. However, each area is universal to the user experiencing the area. Thus, a user in Seattle experiences the same MMO area as a user in Los Angeles and as another user in Hong Kong. This is true even if each user is experiencing substantially different real-world environments.

### SUMMARY

The present disclosure is directed to customized content from user data, substantially as shown in and/or described in connection with at least one of the figures, as set forth more completely in the claims.

### BRIEF DESCRIPTION OF THE DRAWINGS

FIG. 1 presents an exemplary diagram of a system for customized content from user data;

FIG. 2 shows a more detailed diagram of a device for customized content from user data;

FIG. 3A shows a customized virtual experience from real world user data;

FIG. 3B shows a contrasting customized virtual experience from real world user data;

FIG. 3C shows a customized virtual experience from stored user data; and

FIG. 4 presents an exemplary flowchart illustrating a method for customized content from user data.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

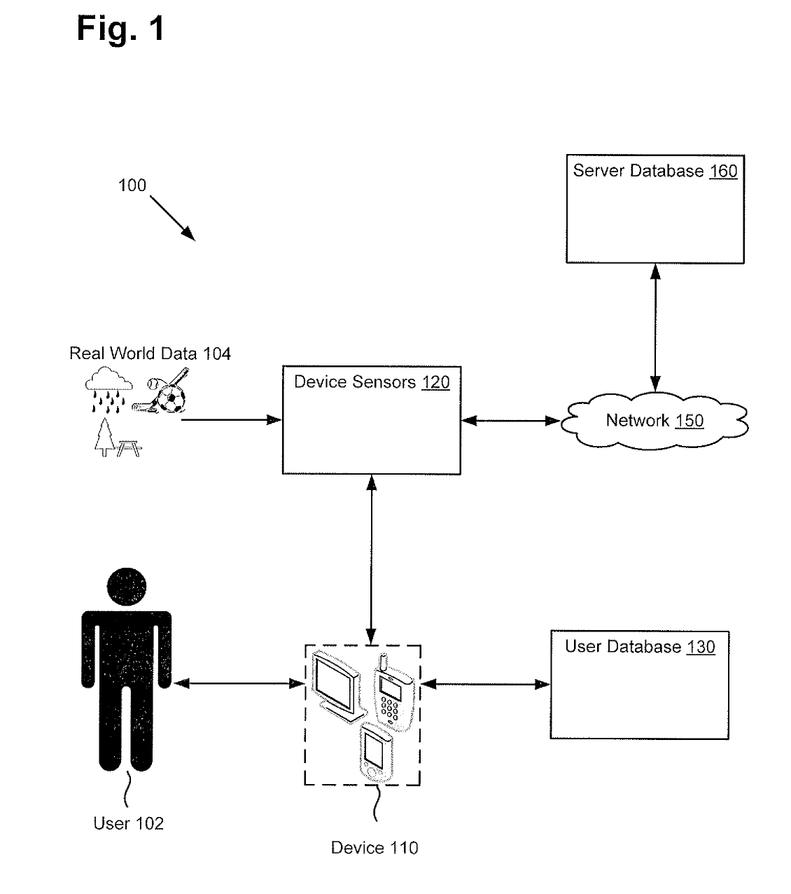

FIG. 1 presents an exemplary diagram of a system for customized content from user data. FIG. 1 includes system environment 100 containing user 102 and real world data 104. Further shown in FIG. 1 is device 100 having device sensors 120 and user database 130. As shown in FIG. 1, user 102 utilizes device 110, for example by accessing, viewing, and interacting with device 110. Device 110 utilizes device sensors 120 to be further connected to server database 160 over network 150 to receive and distribute data and information. Although device 110 is shown as connected or connectable to device sensors 120 and user database 130, in alternate implementations device sensors 120 and user database 130 may be incorporated on device 110. Device 110 may be implemented as a user interactive device capable of receiving user data corresponding to user 102 and displaying content to user 102. Device 110 may include a memory and a processor capable of receiving content, such as music, videos, photographs, interactive games, virtual environments, or other audiovisual content of user 102. Additionally, device 110 may receive and process data corresponding to a user from device sensors 120, user database 130, and over network 150. For example, device 110 may receive real world data 104, such as location information, ambient light levels, or other sensory data from device sensors 120. Additionally, device 110 may receive data as user input, such as profile information, preferences, or other user settings to be saved in user database 130. Moreover, device 110 may access server database 160 over network 150 in order to receive data, such as online music profiles, social media profiles, downloadable content, or other data. Device 110 may store the content and the data in user database 130.

User 102 of FIG. 1 is shown using device 110 to view or access content stored and/or presented on device 110. After receiving the content, device 110 may display the content for interaction by user 102. device 110 may include a display for outputting the content to user 102. However, in other implementations, device 110 may not include the display on or with device 110 and instead have a sufficient output means to transmit the content to an external display. Thus, although in the implementation of FIG. 1 device 110 is shown as a monitor, embedded controller, or a phone, device 110 may be any suitable user device, such as a mobile phone, a personal computer (PC) or other home computer, a personal digital assistant (PDA), a television receiver, or a gaming console, for example.

According to FIG. 1, user 102 in system environment 100 is experiencing real world data 104, shown as rain clouds, sporting events, and park locations. Device 110 is connected to device sensors 120, which may include sensors capable of detecting, receiving, and/or transmitting data, shown as real world data 104, corresponding to user 102. For example, device sensors 120 may correspond to a GPS detector. The GPS detector may detect a location or movement pattern of user 102, and thus be aware of real world data 104 in system environment 100. The GPS sensor may then transmit the data to a processor of device 110. Device sensors 120 may also correspond to a microphone, receiver, accelerometer, camera, or other sensors as will be discussed later. Thus, real world data 104 may correspond to further input detectable by device sensors 120. In another implementation, device sensors 120 may correspond to a data transmission unit capable of receiving sensory data from another data source, such as another device. Thus, device sensors 120 may receive data corresponding to data detected by another device, music playlists, social media profiles, messaging information, or other receivable and transmittable data. Device sensors 120 may be incorporated within device 110, such as embedded in device 110, or may be connectable to device 110. Device sensors 120 may correspond to one device sensor or a plurality of device sensors.

Device 110 of FIG. 1 is also connected to user database 130. User database 130 may correspond to a database stored on a memory. As previously discussed, user database 130 may include user settings, features, or other user associated data. For example, user database 130 may include a song playlist or a history of music choices of user 102. Device 110 may then receive the song playlist or history and be informed of music choices of user 102. In other implementations, user database 130 may store data corresponding to a user as content. For example, photographs, music, or videos may all be used as user data as well. User database 130 may be stored on device 110, such as in a memory of device 110. Thus, in contrast to information received by device sensors 120, user database 130 may correspond to data saved on device 110. User database 130 may also correspond to data previously received using device sensors 120 and stored on device 110. However, user database 130 may also be stored external to device 110, such as on another memory storage unit, and connectable to device 110. User database 130 may correspond to a single database or a plurality of databases.

Device 110 is connected to server database 160 over network 150 utilizing device sensors 120. For example, device sensors 120 may include a data transmission unit capable of detecting, receiving, and transmitting data over network 150 or another communications network. Network 150 may correspond to a network connection, such as a wireless phone service communication network, broadband network, or other network capable of sending of receiving data. Device 110 may receive data corresponding to a user and content from server database 160. Server database 160 may correspond to a website with stored data corresponding to a user. For example, server database 160 may be a social media website, a music profiling website, a user generated content website, cloud computing service, or other database. Server database 160 may also correspond to web services with data, such as weather, census, event, political, or location data services. Device 110 may receive data from server database 160 actively, such as when a user logs on to a website, or may be configured to receive data passively from server database 160.

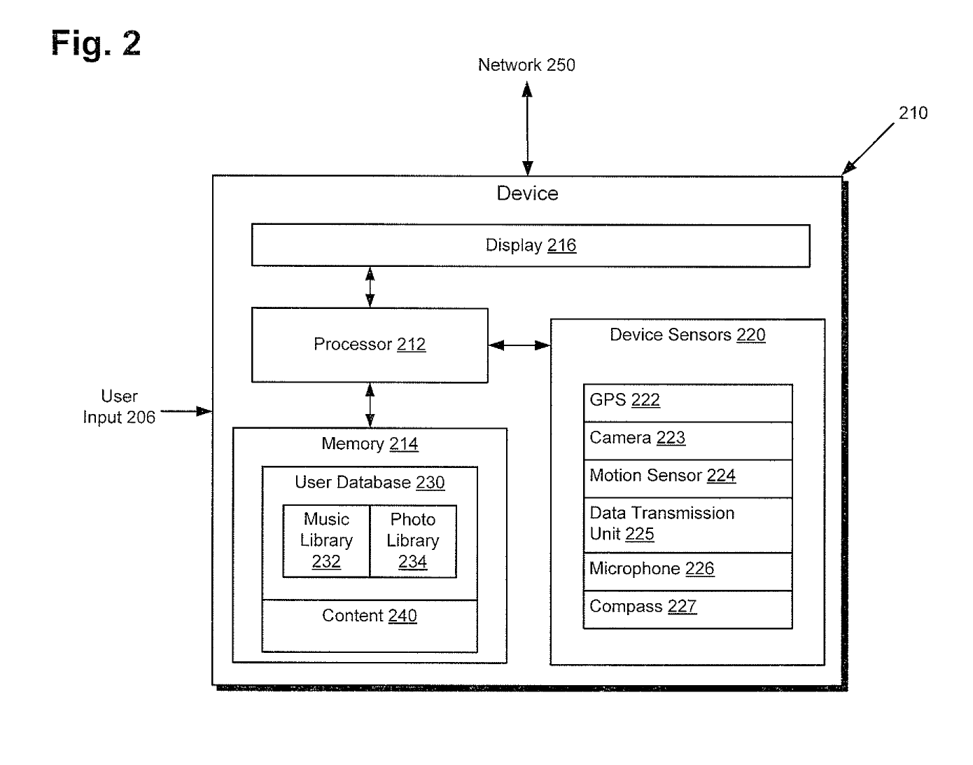

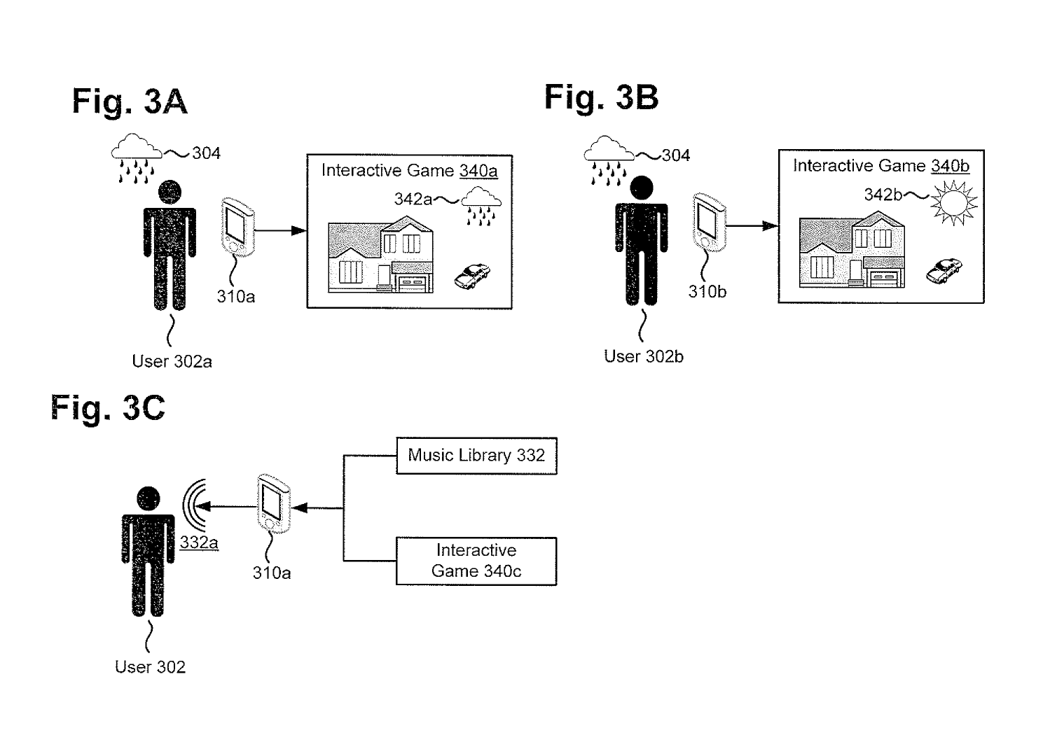

According to FIG. 1, device 110 receives data from device sensors 120, user database 130, and server database 160. As will be discussed in more detail in FIG. 2 and FIG. 3, device 110 may then utilize the data to alter content and present customized and/or personalized content to user 102. As previously discussed, the content may be media content, location information, virtual experiences, such as a virtual world or a social media profile, or other modifiable content. Thus, device 110 may detect and receive data for use in creating customized content.

Moving to FIG. 2, FIG. 2 shows a more detailed diagram of a device for customized content from user data. According to FIG. 2, device 210 is connected to network 250 and may also receive user input 206. Device 210 includes processor 212, memory 214, display 216, and device sensors 220. Stored on memory 214 is user database 230 having music library 232 and photo library 234 as well as content 240. Additionally, as shown in FIG. 2, device sensors 220 include GPS 222, camera 223, motion sensor 224, data transmission unit 225, microphone 226, and compass 227. While device 210 is shown with the aforementioned features, it is understood more or less of these features may be incorporated into device 210 as desired.

According to FIG. 2, device 210 receives user input 206. User input 206 may correspond to active and/or passive input from a user, such as user 102 of FIG. 1. For example, a user may utilize device 210 to enter information or type messages. As previously discussed, a user may input data and information into device 210. For example, the user may also insert a flash memory unit into device 210, a DVD or Blu-Ray into device 210, or may utilize device 210 to enter information, such as date of birth, location, or other data corresponding to the user. Additionally, device 210 may receive user input 206 from other sources, such as links and/or direct connections to nearby devices. Thus, it is understood that the user as well as other entities may provide user input 206 to device 210.

Device 210 of FIG. 2 is shown with processor 212 and memory 214. Processor 212 of FIG. 2 is configured to access memory 214 to store received data, input, and/or to execute commands, processes, or programs stored in memory 214. Processor 212 may correspond to a processing device, such as a microprocessor or similar hardware processing device, or a plurality of hardware devices. However, in other implementations, processor 212 refers to a general processor capable of performing the functions required by device 210. Memory 214 is a sufficient memory capable of storing commands, processes, and programs for execution by processor 212. Memory 214 may be instituted as ROM, RAM, flash memory, or any sufficient memory capable of storing a set of commands. In other implementations, memory 214 may correspond to a plurality memory types or modules. Thus, processor 212 and memory 214 contains sufficient memory and processing units to a necessary for device 210.

FIG. 2 additionally shows display 216 on device 210 in communication with processor 212. Display 216 may correspond to a visual display unit capable of presenting and rendering content for a user. Display 216 may correspond to a liquid crystal display, plasma display panel, cathode ray tube, or other display. Processor 212 is configured to access display 216 in order to render content for viewing by the user. While FIG. 2 shows display 216 as part of device 210, in other implementations, display 216 may be external to device 210 or separate and connectable to device 210. Thus, in certain implementations, such as when device 210 is a television receiver, display 216 may be separate and connectable to device 210. Additionally, display 216 may correspond to one visual display unit or a plurality of visual display units.

Device 210 of FIG. 2 also contains device sensors 220 connected to processor 212. As previously discussed, device sensors 220 may include sensors capable of detecting data corresponding to a user and transmitting the data to processor 212 for use or storage in memory 214. As shown in FIG. 2, device sensors 220 include GPS 222, camera 223, and motion sensor 224. GPS 222 may correspond to a global positioning unit or similar unit capable of determining a location of a user. Camera 223 may include a photographing unit capable of capturing and/or saving photographs. Motion sensor 224 may correspond to a sensor unit capable of detecting motions of device 210, such as an accelerometer, gyroscope, inclinometer, or gravity-detecting sensor.

Device sensors 220 further include data transmission unit 225, microphone 226, and compass 227. Data transmission unit 225 may be a sensor capable of detecting, receiving, and transmitting data. Device 210 may utilize network 250 to send and receive data or may send and receive data over other communication links. However, in other implementations, data transmission unit 225 may incorporate a short-range wireless communications link, such as infrared, radio, Bluetooth, or other communication link. Thus data transmission unit 225 may be any suitable means for transmitting, receiving, and interpreting data. Microphone 226 may correspond to a general audio detecting sensor, such as an acoustic to electric sensor utilized in mobile phones to receive audio communications. Device sensors 220 also include compass 227, which may correspond to a sensor capable of detecting earth magnetic poles and thereby determining general movements of a user.

While device sensors 220 of FIG. 2 include sensors 222-227, in other implementations, device sensors 220 may be configured differently, having more, less, or different sensors. For example, device sensors 220 may include an ambient light sensor, thermometer, barometer, or other sensors. Device sensors 220 may correspond to sensors embedded in device 210 or sensors connectable to device 210. For example, device 210 may contain microphone 226 attachable to device 210, such as through an audio connection or data transmission unit 225. Thus, device 210 may receive data from sensors external and connectable to device 210.

As shown in FIG. 2, memory 214 contains user database 230 including music library 232 and photo library 234, as well as content 240. As previously discussed user database 230 may be a database of storable content, data, and information corresponding to a user. According to FIG. 2, user database 230 contains music library 232 and photo library 234 received from network 250, user input 206, and/or device sensors 220. Thus, user database 230 contains music downloaded or stored by the user and photos stored or taken with device 210, as well as any other received data and/or content. Additionally, memory 214 may store content 240. As will be discussed in more detail later, content 240 may correspond to a virtual experience customized using data stored in user database 230 and/or data received from device sensors 220. Although FIG. 2 shows memory 214 containing user database 230 having music library 232 and photo library 234 and content 240, in other implementations, memory 214 may store additional content and data corresponding to a user. For example, memory 214 may additionally store user settings, maps, or other data. Memory 214 may contain other content, such as a social media profile and/or digital artwork.

Device 210 of FIG. 2 is connected to network 250 utilizing data transmission unit 225. As previously discussed, device 210 may be capable of sending and receiving data over network 250, such as a wireless phone service communication network, using data transmission unit 225. Device 210 may be configured as a laptop as well, capable of receiving and transmitting data on a broadband communication network. Additionally, device 210 may be configured as a television receiver or a streaming television receiver capable of sending and receiving information over a cable or satellite communication network. As previously discussed, network 250 may allow device 210 to connect to server databases and receive data corresponding to a user, such as online accounts, messages, and data services. Thus, device 210 may use network 250 to receive and transmit data during operation.

As described above, processor 212 may receive data corresponding to a user from device sensors 220. In certain implementations, processor 212 may receive location information from GPS 222 that corresponds to a location of a user when device 210 is with or near the user. Additionally, processor 212 may access camera 223 to view a surrounding environment or may receive information from camera 223 when the user utilizes camera 223, such as ambient light levels. Further, processor 212 may detect movement from motion sensor 224 and may receive user data from data transmission unit 225. Further sensory data may also be received from microphone 226 and/or compass 227.

Processor 212 may receive instructions from the user to access device sensors 220 and collect data, for example by taking a picture. However, in other implementations, processor 212 passively monitors device sensors 220 without user action. When processor 212 passively monitors device sensors 220, processor 212 may collect data using a background processes without user action. For example, processor 212 may consistently monitor GPS 222, or may sample GPS locations as discreet intervals. By monitoring device sensors 220, processor 212 of device 210 may receive data from user commands or may passively monitor device sensors 220 and collect data without user action.

As previously discussed and shown in FIG. 2, processor 212 of device 210 is connected and in communication with memory 214. Memory 214 contains user database 230 with music library 232. Processor 212 may also receive data corresponding to a user from memory 214. For example, the user may utilize music library 232 to play a set of songs. Processor 212 may receive the playlist or may even view music library 232 to determine music the user enjoys. Additionally, processor 212 may view photo library 234 and determine where the user is or has been, or what the user likes to do. This may be further aided using image recognition software. As previously discussed, user database 230 may contain further data, such as user age, sex, address, or other information corresponding to the user.

Utilizing data received from either or both of device sensors 220 and user database 230, processor 212 of device 210 may provide a customized virtual experience. As previously discussed, content may be received by processor 212 of device 210 over network 250 or through user input 206. As shown in FIG. 2, content 240 is stored in memory 214. Utilizing the data received from device sensors 220 and/or user database 230, processor 212 may alter, change, or otherwise process content 240. Thus, once processed, content 240 may contain elements that correspond to the received data. For example, if processor 212 receives information on a weather pattern at a location of a user, content 240 may mimic or contrast that weather pattern. Further customized virtual experiences will be explained in more detail with reference to FIGS. 3A-3C.

Moving to FIG. 3A, FIG. 3A shows a customized virtual experience from real world user data. As shown in FIG. 3A, FIG. 3A includes user 302a utilizing device 310a to play interactive game 340a. As shown in FIG. 3A, user 302a is experiencing weather 304, while interactive game 340a is displaying customized virtual environment 342a.

According to FIG. 3A, user 302a may utilize device 310a, such as a video game console, PDA, smart phone, or other user device as previously discussed. Device 310a may contain content, such as interactive game 340a. Device 310a may contain different or additional content, such as music playlists, social media profiles, photo slideshows, or other content. Thus, user 302a may utilize device 310a to access and/or play the content.

As previously discussed, device 310a may contain device sensors capable of actively or passively detecting data corresponding to a user. Data may correspond to environmental conditions, geographic positions, audio levels, ambient light levels, or movement of user 302a and/or device 310a. Data may correspond to the context of user 302a, such as a condition of user 302a. Data may also correspond to digital data corresponding to user 302a, such as music/video playlists, music/video libraries, social media profiles, contact information, or other available data. Thus, device 310a may receive data pertaining to user 302a.

As shown in FIG. 3A, user 302a is experiencing weather 304. Weather 304 is shown as a rainy environment condition. Device 310a may receive data corresponding to weather 304. For example, device 310a may receive data in the form of location information from a device sensor, such as a GPS sensor. Using a network connection of device 310a, device 310a may utilize the location data to determine weather 304 corresponding to user 302a. While device 310a is shown receiving data pertaining to weather 304 of user 302a, in other implementations device 310a may receive different data. For example, device 310a may receive the location information identifying a specific location of user 302a, such as home, work, travel, or other designated location. As previously discussed, device 310a may have a microphone to detect sound corresponding to user 302a. Thus, it is understood that device 310a may receive more or different data than weather 304.

Using data received, device 310a may process the data with interactive game 340a. As shown in FIG. 3A, interactive game 340a is displaying customized virtual environment 342a. Customized virtual environment 342a is shown as a weather effect corresponding to weather 304. Device 310a may utilize data, in the form of location information obtained from a device sensor, to determine weather 304. Once device 310a receives weather 304, device 310a may process weather 304 with interactive game 340a. As shown in FIG. 3A, device 310a has incorporated data corresponding to weather 304 to alter interactive game 340a to display customized virtual environment 342a. While FIG. 3A displays customized virtual environment 342a as the customized content, it is understood that customized virtual environment 342a may correspond to a different customized content. Thus, customized virtual environment 342a may correspond to music, video, images, or other content that matches the received data.

In other implementations, customized virtual environment 342a may include an effect corresponding to the received data. As previously discussed, the data may correspond to a particular location of an individual, such as a theme park location. Thus, device 310a displaying customized virtual environment 342a may dim application brightness, deliver maps, or otherwise customize content delivered to user 302a based on the location data.

In contrast to FIG. 3A, FIG. 3B shows a contrasting customized virtual experience from real world user data. FIG. 3B shows a contrasting customized virtual experience from real world user data. As shown in FIG. 3B, user 302b utilizes device 310b to access interactive game 340b. User 302b is also experiencing weather 304 similar to user 302a of FIG. 3A. However, in FIG. 3B, interactive game 340b of device 310b displays interactive game 430b with customized virtual environment 342b.

According to FIG. 3B, device 310b is configured to provide interactive game 340b to user 302b. User 302b is experiencing weather 304 similar to user 302a of FIG. 3A. However, in contrast to user 302a, user 302b experiences customized virtual environment 342b, which is different than customized virtual environment 342a of FIG. 3A. In FIG. 3B, device 310 is configured to provide a contrasting virtual experience from received data. Thus, when device 310 receives data corresponding to weather 304, device 310b processes the data with interactive game 340b. However, device 310b processes the data to provide customized virtual environment 342b with contrasting weather 304, shown in FIG. 3B as sunny weather in interactive game 340b. Thus, device 310b may provide user 302b with contrasting customized content instead of content mirrored to real world data corresponding to user 302b.

While FIG. 3B shows device 310b processing weather 304 with interactive game 340b to create customized virtual environment 342b, in other implementations different data may be processed with a content to provide a different contrasting content. For example, device 310b may receive location information from a GPS sensor as previously discussed. Location information may correspond to a set home location. Thus, device 310b receive data determining user 302b is at home. In such an implementation, device 310b may process the location information with interactive game 340b to provide a contrasting virtual environment, such as a beach or vacation destination.

Additionally, while FIG. 3B displays customized virtual environment 342b as customized content, it is understood that customized virtual environment 342b may correspond to a different customized content. Customized virtual environment 342b may correspond to music, video, images, or other content that contrasts the received data. For example, customized virtual environment 342b may play happy music is weather 304 corresponds to rainy weather. Thus, device 310b may provide a variety of contrasting content to data corresponding to user 302b.

Moving to FIG. 3C, FIG. 3C shows a customized virtual experience from stored user data. As shown in FIG. 3C, user 302c is using device 310c to view, play, and/or interact with interactive game 340c of device 310c. As further shown in FIG. 3c, device 310c contains music library 332 and is outputting music 332a to user 302c. Music library 332 may be stored on device 310c or may be accessible to device 310c as stored information.

According to FIG. 3C, device 310c may receive stored data from music library 332. As discussed with FIG. 2, device 310c may contain a memory with a user database stored containing music library 332. In another implementation, device 310c may have access to a memory with a stored user database containing music library 332. Device 310c has access to music library 332 corresponding to user 302c. Using music library 332, device 302c may determine music choices of user 302c, music playlists, or other music genres corresponding to user 302c. Thus, device 310c receives data from music library 332.

Utilizing music library 332, device 310c may process context information received from music library 332 with interactive game 340c. Device 310c may incorporate music from music library 332 with interactive game 340c, such as providing music 332a as background music during interactive game 340c. In other implementations, device 310c may utilize a playlist in music library 332 with interactive game 302c. Device 310c may also receive data from music library 332 and use the data to determine a music genre corresponding to user 302c. For example, device 310c may contain music recognition or archiving software or be connected to a network in order to access these features. Using music library 332, device 310c may determine a music genre corresponding to user 302c. Device 310c may utilize the music genre to provide music 332a received over the network to user 302c or chose music 332a from music library 332 to play during interactive game 340c.

In other implementations, device 310c may utilize data accessible by device 310c with different content. For example, device 310c may utilize music library 332 to play a song list during presentation of a slideshow of photos on device 310c. Additionally, device 310c may otherwise process data accessible by device 310 with content. For example, stored photographs on device 310c may be processed with interactive game 340c, such as by adding backgrounds, locations, or people from photographs in interactive game 340c.

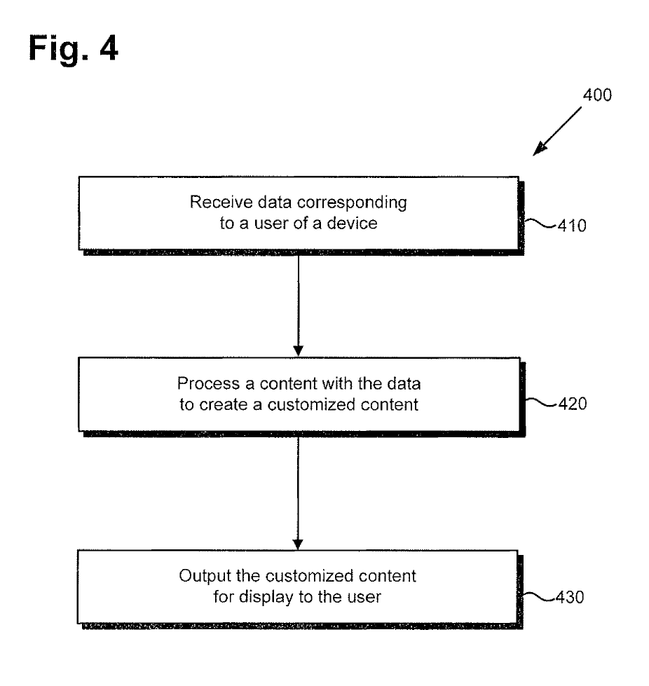

FIGS. 1, 2, 3A, 3B, and 3C will now be further described by reference to FIG. 4, which presents flowchart 400 illustrating a method for customized content from user data. With respect to the method outlined in FIG. 4, it is noted that certain details and features have been left out of flowchart 300 in order not to obscure the discussion of the inventive features in the present application.

Referring to FIG. 4 in combination with FIG. 1, FIG. 2, FIG. 3A, FIG. 3B, and FIG. 3C, flowchart 400 begins with receiving data corresponding to a user 102/302a/302b/302c of a device 110/210/310a/310b/310c (410). The receiving may be performed by processor 212 of device 110 or device 210/310a/310b/310c. Processor 212 may receive data, such as real world data 104, weather 304, music library 232/332, and/or photo library 234. As previously discussed, device 110 or device 210/310a/310b/310c may receive data from device sensors 220, for example by sampling location, sounds, or other data, or from stored data, such as user database 230 containing music library 232/332. The data may correspond to a feature, condition, preference, and/or other characteristic of user 102/302a/302b/302c, informational data corresponding to user 102/302a/302b/302c, or other receivable data.

Flowchart 400 continues by processing a content 240 with the data to create a customized content (420). Processor 212 may perform the processing the content with the data. As previously discussed, processor 212 may receive data corresponding to user 102/302a/302b/302c, such as real world data 104, weather 304, music library 232/332, and/or photo library 234. Processor 212 of device 110 or device 210/310a/310b/310c may utilize the data with content 240, such as interactive game 340a/340b/340c or a virtual environment of interactive game 340a/340b/340c. Content 240 may also include music playlists, photography slideshows, device applications, television shows or movies, and/or other content. After processing the content with the data, a customized content is created, such as customized virtual environment 342a/342b. In another implementation, the customized content may be interactive game 340c playing music 332a. Other exemplary customized content may correspond to photography slideshows using music genre information from music library 232/332, playlists using location information from GPS sensor 222, or updated social media profiles using camera 223 and/or GPS 222.

Flowchart 400 of FIG. 4 continues with outputting the customized content for display to the user 102/302a/302b/302c (430). The outputting may be performed by processor 212 utilizing display 216 of device 110 or device 210/310a/310b/310c. As previously discussed, display 216 may be incorporate in device 110 or device 210/310a/310b/310c or may be detached but connectable to device 110 or device 210/310a/310b/310c. Once processor 212 has created the customized content, processor may output the customized content to display 216 for consumption by user 102/302a/302b/302c. For example, user 102/302a/302b/302c may view interactive game 340a/340b with customized virtual environment 342a/342b. In another implementation, user 102/302a/302b/302c may play interactive game 340c with music 332a from music library 232/332.

Utilizing the above, customized content may be created for user using data taken from a device. Users may receive updated and personalized content based on active or passive monitoring of device sensors and user databases. Thus, users may feel the convenience and additionally attachment to targeted content.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method for providing a user with a customized content, the method comprising:
receiving data corresponding to a user of a device;
processing a content with the data to create the customized content; and
outputting the customized content for display to the user.

2. The method of claim 1, wherein the receiving the data further comprises receiving the data from a device sensor.

3. The method of claim 2, wherein the device sensor is a GPS sensor.

4. The method of claim 2, wherein the device sensor is one of a camera, an accelerometer, and a receiver.

5. The method of claim 1, wherein the data includes a location of the user.

6. The method of claim 5, wherein the data further includes location data corresponding to the location of the user.

7. The method of claim 1, wherein the data includes user information received from a database corresponding to the user.

8. The method of claim 1, wherein the content is a virtual environment and the customized content is the customized virtual environment.

9. The method of claim 8, wherein the customized virtual environment corresponds to a real environment of the user.

10. A device for providing a user with a customized content, the device comprising:
a control unit including a processor, the processor configured to:
receive data corresponding to a user of the device;
process a content with the data to create the customized content; and
output the customized content for display to the user.

11. The device of claim 10, wherein the device further includes at least one device sensor, and wherein the processor is further configured to receive the data from the at least one device sensor.

12. The device of claim 11, wherein the at least one device sensor is a GPS sensor.

13. The device of claim 11, wherein the at least one device sensor is one of a camera, an accelerometer, and a receiver.

14. The device of claim 10, wherein the data includes a location of the user.

15. The device of claim 14, wherein the data further includes location data corresponding to the location of the user.

16. The device of claim 10, wherein the data includes user information received from a database corresponding to the user.

17. The device of claim 10, wherein the content is a virtual environment and the customized content is the customized virtual environment.

18. The device of claim 17, wherein the customized virtual environment corresponds to a real environment of the user.

19. A mobile device for providing a user with a customized content, the mobile device comprising:
a display;
a control unit including a processor, the processor configured to:
receive data corresponding to a user of the mobile device;
process a content with the data to create a customized content; and
output the customized content to the display.

20. The mobile device of claim 19, wherein the device further includes at least one device sensor, and wherein the at least one sensor includes one of a GPS sensor, a camera, an accelerometer, and a receiver.
